(19) United States
(12) Patent Application Publication
(10) Pub. No.: US 2021/0365568 A1
(43) Pub. Date: Nov. 25, 2021

(54) PRIVACY PRESERVING APPROACH TO PEAK LOAD MANAGEMENT

(71) Applicant: Cleveland State University, Cleveland, OH (US)

(72) Inventor: Hongxing Ye, Westlake, OH (US)

(73) Assignee: Cleveland State University, Cleveland, OH (US)

(21) Appl. No.: 17/326,796

(22) Filed: May 21, 2021

Related U.S. Application Data
(60) Provisional application No. 63/029,119, filed on May 22, 2020.
(60) Provisional application No. 63/029,219, filed on May 22, 2020.

(51) Int. Cl. G06F 21/60; G05B 13/04; H02J 3/00

(52) U.S. Cl. CPC G06F 21/60; H02J 2203/20; H02J 3/00; G05B 13/042

(57) ABSTRACT

The present exemplary embodiments relate to a privacy preserving approach to peak load management. It finds example application in conjunction with, for example, power systems, such as smart homes, smart buildings, microgrids, distribution systems and bulk systems, and energy management systems.

The present application claims priority to U.S. Provisional Patent Application Ser. No. 63/029,119 filed May 22, 2020 and to U.S. Provisional Patent Application Ser. No. 63/029,219 filed May 22, 2020, both of which are incorporated entirely herein by reference.

This invention was made with government support under Transactive Uncertainty and Flexibility for High Penetration of Semi-dispatchable Renewables in Electricity Markets (Grant No. ECCS 1711217) awarded by The National Science Foundation. The government has certain rights in this invention.

### TECHNICAL FIELD

The present exemplary embodiments relate to a privacy preserving approach to peak load management. It finds example application in conjunction with, for example, power systems, such as smart homes, smart buildings, microgrids, distribution systems and bulk systems, and energy management systems, and will be described with particular reference thereto. However, it is to be appreciated that the present exemplary embodiments are also amenable to other like applications.

### BACKGROUND

It is fundamentally important from both economic and security perspectives to manage the peak load in electricity systems on all different scales. In current approaches, it is often necessary to collect load profiles from an individual/agent (e.g., household, building, campus, load service entity, etc.). Doing so jeopardizes privacy and security, as one could easily figure out what activities the individual or agent is conducting with load profiles. At the same time, it is computationally expensive to optimally manage the peak load, even using the state-of-art commercial optimization solvers.

### BRIEF DESCRIPTION

In accordance with one aspect of the presently described embodiments, a privacy preserving method for peak load management of group agents in a power and/or energy system comprises aggregating load for each group by a group agent, selectively providing the aggregated load for each group to a system operator and managing a peak load of the system, whereby the managing preserves privacy and attains improved, nearly-optimal or optimal solutions.

In accordance with another aspect of the present described embodiments, a privacy preserving system for peak load management of groups in a power and/or energy system comprises a group agent configured to aggregate load for a group and/or a system operator configured to selectively manage a peak load of the system based on at least the aggregated load of the group to preserve privacy and attain improved, nearly-optimal or optimal solutions.

In accordance with another aspect of the presently described embodiments, a privacy preserving method for peak load management of groups in a power and/or energy system comprises locally optimizing or improving activities and aggregating load in each group agent, broadcasting selected aggregated information with or without noise to a system operator or agents for each group and managing a peak load of the system based on at least the selected aggregated information, whereby the managing preserves privacy and attains improved, near-optimal or optimal solutions. In accordance with another aspect of the presently described embodiments, a Lagrange multiplier is implemented.

In another aspect of the presently described embodiments, a privacy preserving system for peak load management of groups in a power and/or energy system comprises a group agent configured to locally optimize or improve activities, aggregate load for a group, and determine selected aggregated information and a system operator configured to selectively manage a peak load of the system based on at least the selected aggregated information to preserve privacy and attain improved, near-optimal or optimal solutions.

In accordance with another aspect of the presently described embodiments, a Lagrange multiplier is implemented.

In accordance with another aspect of the presently described embodiments, a privacy preserving system for peak load management of groups in a power and/or energy system, the system comprises at least one processor and at least one memory having stored thereon code or instructions that, when executed by the processor locally optimize or improve activities and aggregate load in each group agent, broadcast selected aggregated information with or without noise to a system operator or agents for each group, and manage a peak load of the system based on at least the selected aggregated information, whereby the managing preserves privacy and attains improved, near-optimal or optimal solutions.

In accordance with another aspect of the presently described embodiments, a Lagrange multiplier is implemented.

In accordance with another aspect of the presently described embodiments, a privacy preserving system for peak load management of groups in a power and/or energy system, the system comprises a group agent comprising at least one processor and at least one memory having stored thereon code or instructions that, when executed by the processor to locally optimize or improve activities, aggregate load for a group, and transmit selected aggregated information to a system operator configured to selectively manage a peak load of the system based on at least the aggregated information to preserve privacy and attain improved, near-optimal or optimal solutions.

In accordance with another aspect of the presently described embodiments, a Lagrange multiplier is implemented.

In accordance with another aspect of the presently described embodiments, a privacy preserving method for peak load management of groups in a power and/or energy system, the method comprises a group agent locally optimizing or improving activities, aggregating load for a group, and transmitting to a system operator selected aggregated information, the system operator being configured to selectively manage a peak load of the system based on at least the aggregated information to preserve privacy and attain improved, near-optimal or optimal solutions.

In accordance with another aspect of the presently described embodiments, a Lagrange multiplier is implemented.

In accordance with another aspect of the presently described embodiments, a privacy preserving system for peak load management of groups in a power and/or energy system, the system comprises a system operator comprising at least one processor and at least one memory having stored thereon code or instructions that, when executed by the processor, receives iteratively selected aggregated information representing aggregate load from at least one group agent, selectively manages a peak load of the system based on at least the aggregated information to preserve privacy and attains improved, near-optimal or optimal solutions.

In accordance with another aspect of the presently described embodiments, a Lagrange multiplier is implemented.

In accordance with another aspect of the presently described embodiments, a privacy preserving method for peak load management of groups in a power and/or energy system, the method comprises a system operator receiving iteratively selected aggregated information aggregate load from at least one group agent, and selectively managing a peak load of the system based on at least the aggregated information to preserve privacy and attain improved, near-optimal or optimal solutions.

In accordance with another aspect of the presently described embodiments, a Lagrange multiplier is implemented.

### BRIEF DESCRIPTION OF THE DRAWINGS

FIG. 1 illustrates peak load management:

FIG. 2 is an illustration of a system according to the presently described embodiments;

FIG. 3 is an illustration of a system component according to the presently described embodiments;

FIG. 4 is an illustration of a system component according to the presently described embodiments;

FIG. 5 is a flowchart for an example method according to the presently described embodiments; and

FIG. 6 is a flowchart for an example method according to the presently described embodiments.

### DETAILED DESCRIPTION

According to the presently described embodiments, a novel privacy-preserving framework is provided to manage the peak load of a system. Without having the detailed profiles (for example, for any particular group or individual or agent within the system), which can include or reflect privacy or security information, the presently described embodiments efficiently manage the peak load using a novel algorithm. In at least one form, a system operator can manage the peak load for the system based on many groups or individuals or agents according to the presently described embodiments. In at least one form, the system operator may manage the peak load for a group or agent or individual locally. In such a configuration, the operator managing the peak load may also reside locally. It should be appreciated that peak load management according to the presently described embodiments may also be performed on multiple levels of the system or groups or individuals or agents in combination or cooperation with one another. It should also be appreciated that, in example contemplated configurations, the system operator, or operator(s), that manage(s) the peak load could take a variety of forms, could operate on a variety of or multiple levels of the system or groups or individuals or agents, and could be centralized or distributed as appropriate for the implementation. The new method is proved to have polynomial solution time. The speed significantly outperforms the state-of-art commercial optimization solvers.

The presently described embodiments can be used in a variety of environments including load management in different scale power systems, such as smart home, smart building, microgrid, distribution system, and bulk system, as well as in energy management systems.

The advantages include, without limitation, preserving the privacy of individuals or groups or agents whose load data is measured or predictable based on provided information. Also, an overwhelming advantage of computational performance is achieved.

Peak load management is essential from both economic and security perspectives in the energy systems, as electricity is often expensive at peak period, and the system becomes more vulnerable when operating under high peak loading.

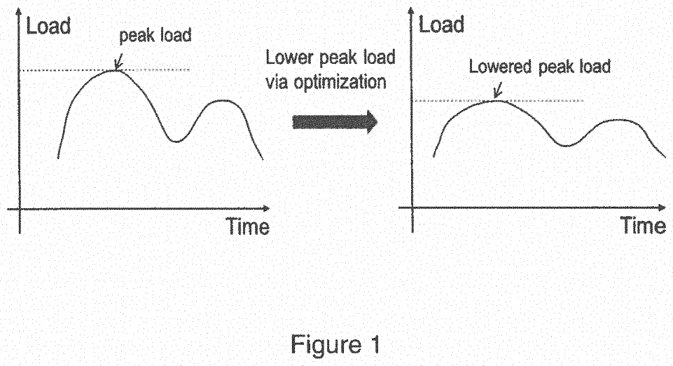

FIG. 1 illustrates an example of peak load management wherein load v. time curves illustrate but one example of how peak loads can be lowered over time periods via optimization techniques.

In order to manage the peak load, a utility or system operator must collect energy consumption information for activities. Sensitive information of an individual or group or agent can be revealed with detailed energy consumption profiles. The presently described embodiments provide a new approach to preserve sensitive information for peak management. An objective is to design new and scalable methodologies to improve or optimize the peak load using aggregated anonymous load information. A feature of the presently described embodiments is that the optimal, near optimal or improved solution for each activity can be efficiently attained without disclosing activity information to an untrustworthy party. Compared with approaches using the state-of-art commercial optimization solver, the presently described embodiments have overwhelming computational performance, which is verified from both theoretical proof and numerical study.

More specifically, as an example, denote i, j as the index of activity, and bid. A bid typically takes into account energy consumption over a given period of time. Let I Ji, and T be the set of activities, bids for activity i, and planning periods, respectively. u is a utility value or a value of energy consumption. This value can take a variety of forms including, for example, an assigned value, a variable, or an electricity rate. Depending on the implementation, u can be controlled in a variety of ways including, for example, by the user (for example, to represent importance to the user), the group agent (for example, to represent cost to the system) or a combination of both.

The decision variables include the binary variable xᵢⱼ and peak load ϕ. The peak load ϕ is a variable determined by energy activity. The binary variable xᵢⱼ can be, for example, used to identify selected time periods over which energy consumption is expected. Also, C is a constant that represents, in at least one form, charge or cost.

The optimization problem of managing the peak load is modeled as:

$${max}_{x} {\sum }_{i ∈ ℐ} {\sum }_{j ∈ {𝒥}_{i}} {x}_{ij} {u}_{ij} - c \cdot ϕ \\ ( P ) s . t . {\sum }_{i ∈ ℐ} {\sum }_{j ∈ {𝒥}_{i}} {x}_{ij} {P}_{ij , t} \leq ϕ , t ∈ 𝒯$$

$${\sum }_{j ∈ {𝒥}_{i}} {x}_{ij} \leq 1 , i ∈ ℐ$$

$${x}_{ij} ∈ \{ 0 , 1 \} , i ∈ ℐ , j ∈ {𝒥}_{i}$$

To solve this problem (P) without revealing the detailed energy consumption profiles for each activity (and bid) for a given time, P_{ij,t}, the presently described embodiments, in at least one form, employ a novel decomposition algorithm. First of all, we introduce a Lagrange function (where A is a Lagrange multiplier and Λ and xᵢ are sets, defined below):

$${ℒ}_{i} ( {x}_{i} , λ ) = {\sum }_{j} - {x}_{ij} {u}_{i j} + {\sum }_{t} {\sum }_{j} {λ}_{t} {x}_{i j} {P}_{i j , t} ,$$

where xᵢ={xᵢⱼ}_{j∈J}, and λ={Δₜ}_{t∈T}. Define

$$Λ {=}^{Δ} \{ {\{ λ \}}_{t ∈ 𝒯} \vert {\sum }_{t} {λ}_{t} = c , {λ}_{t} \geq 0 , t ∈ 𝒯 \} , and$$

$${𝒳}_{i} = \{ {x}_{ij} \vert {\sum }_{j} {x}_{i j} \leq 1 , {x}_{i j} ∈ \{ 0 , 1 \} , j ∈ 𝒥 \} .$$

Then, we summarize the general framework (with k being an iterative index and α being a parameter indicating step size) as follows:

| | |
|---|---|
| 1: | Set k = 0, initialize λ⁰, x⁰ |
| 2: | while not converged do |
| 3: | for i ← 1 to I do |
| 4: | ${x}_{i}^{k + 1} ∈ arg {min}_{{x}_{i} ∈ {X}_{i}} {L}_{i} ( {x}_{i} , {λ}^{k} )$ |
| 5: | end for |
| 6: | Update λ^{k+1} using the projection of λ^{k} + α^{k} · ΣᵢΣⱼxᵢⱼ^{k+1}Pᵢⱼ |
| | on Λ |
| 7: | k ← k + 1 |
| 8: | end while |

The algorithm above only needs information of sum of xᵢⱼ^{k+1}Pᵢⱼ.

We hence could aggregate load into different groups during the iteration process. The group can be in different levels, such as home, building, community, microgrid, etc. Denote the set of activities in group g as I_{g}. The aggregated load in group g is D_{gt}^{k}=Σ_{i∈I}_{_{g}}xᵢⱼ^{k+1}Pᵢⱼ.

Two or more groups could submit manipulated data with consensus, as long as the sum of aggregated load remains same. For instance, if group g₁ and g₂ reach an agreement, then they could submit D_{g}_{₁}ₜ^{k}+ξ and D_{g}_{₂}ₜ^{k}−ξ instead of D_{g}_{₁}ₜ^{k} and D_{g}_{₂}ₜ^{k}.

Thus, in the process, as shown and described, each group agent submits aggregated load D_{gt}^{k} anonymously. Alternatively, manipulated data could be submitted as well. λₜ^{k} can be updated with aggregated system-wide load by a third party (e.g., a system operator) or a group agent.

Next, we present how to effectively solve Item 4 and Item 6. In this regard, it should be appreciated that the general framework including Item 1 through Item 8 above, and related functionality, represents a technique to be implemented by a system according to the presently described embodiments. Each Item may be implemented by one or more suitable components of a system. However, in at least one form, Item 4 is implemented by, for example, the group agent(s), and Item 6 is implemented by a system operator or other entity that calculates the Lagrange multiplier according to the presently described embodiments. Likewise, in at least one form, Item 1 may be implemented by the system operator or other entity.

Item 4 is an optimization problem. We find an analytical solution to it. Given λ^{k}, the optimum is:

$${min}_{{x}_{i} ∈ {𝒳}_{i}} {ℒ}_{i} ( {x}_{i} , {λ}^{k} ) = {min}_{j ∈ 𝒥} \{ - {u}_{i j} + {\sum }_{t} {λ}_{t}^{k} {P}_{i j , t} \}$$

and if j*∈ [symbol] {−uᵢⱼ+Σₜλₜ^{k}P_{ij,t}}, then a minimum is:

$${x}_{i j}^{k + 1} = \{ \begin{matrix}1 , & j = {j}^{*} \\ 0 , & j ∈ 𝒥 ∖ {j}^{*}\end{matrix} .$$

In Item 6, the projection is:

Let {\tilde{λ}ₜ=λₜ^{k}+α^{k}. ΣᵢΣⱼxᵢⱼ^{k+1}P_{ij,t}} [symbol] . Projection on Λ is

$${λ}_{t}^{k + 1} = \{ \begin{matrix}{\tilde{λ}}_{t} - {y}^{*} & if {y}^{*} < {\tilde{λ}}_{t} \\ 0 & if {y}^{*} \geq {\tilde{λ}}_{t}\end{matrix} ,$$

and y* is an unique solution to Σₜ max{\tilde{λ}ₜ−y,0}=c.

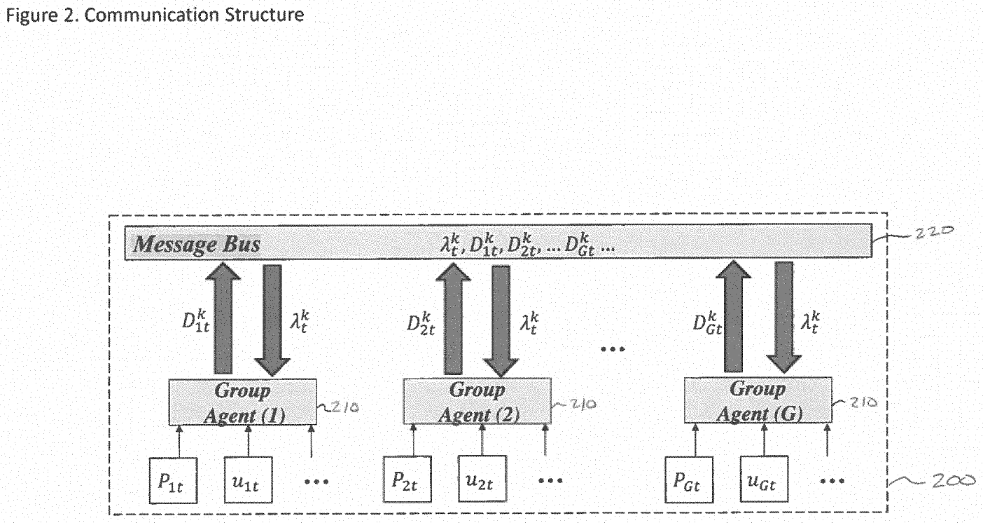

FIGS. 2, 3 and 4 show an illustrative framework. As shown in FIG. 2, a system 200 includes group agents 210 connected to a message bus 220. The group agents 210 collect energy consumption profiles P_{Gt} and utility values u_{Gt}. This information is collected as part of a load management system that, as noted above, could be implemented in a variety of different forms and in a variety of different environments where, for example, monitoring and/or controlling the use and/or cost of energy, for example, has value. In at least one example, the energy consumption profiles represent expected energy consumption of a user at or over a given time. The user, which would take a variety of forms including a house, building, laboratory, building floor, or any entity or device that consumes energy, provides this information (e.g., energy consumption profile) to the group agent based on its expected energy use of, for example, machinery, appliances, etc. The utility value of such energy consumption, as defined above, is also provided. The techniques for providing this information to the group agents by the users can vary; however, in at least one form, include a relatively simple transmission of information using data transmission techniques and systems.

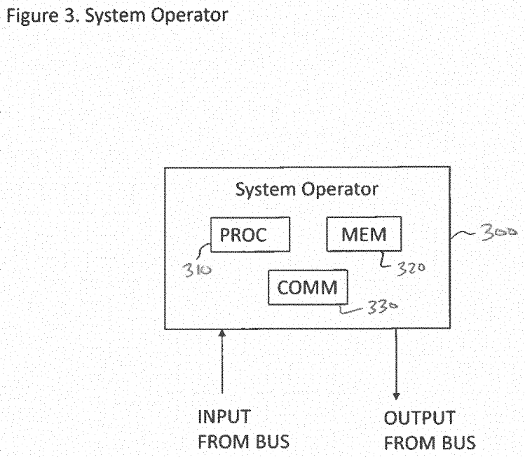

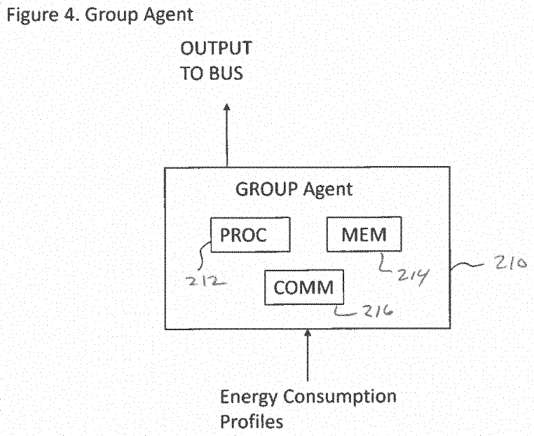

One of the group agents, or a separate element (not specifically shown in FIG. 2), can also perform as a system operator to receive input from the message bus and transmit information or output to the message bus. The system operator may be implemented in a variety of ways. In one example, the system operator is an entity with peak load management responsibility such as, for example, a public utility entity, a proxy therefor, or an entity related to a collection or campus of buildings or homes. As shown in FIG. 3, an example system operator 300 includes a processor 310, memory 320, and communication interface or module 330 configured to transmit and receive data. Similarly, as shown in FIG. 4, a group agent 210 may take an example form including a processor 212, memory 214, and communication interface or module 216 configured to transmit and receive data. The group agent could likewise take a variety of forms including an entity representing a collection or group of users. A group agent may take the form of an entity representing a group of houses in a neighborhood or a subset of buildings on a campus, or may even be provided, for example, for a single home including multiple devices that consume energy.

As described herein, the group agents 210 aggregate the data received and send it (e.g., the sum) to the system operator 300. Notably, this aggregation or sum does not indicate the source (or user) for any aspect of the information. Therefore, privacy is maintained. The system operator 300 then calculates a Lagrange multiplier λₜ and provides those Lagrange multipliers to the respective group agents—which then aggregate and refine their information and send further aggregated information to the system operator 300, which continues to update the Lagrange multiplier. This is an iterative process that continues until convergence is reached. That is, the process continues to iterate until the system operator determines a peak load management solution for the given time periods.

As noted, the system operator 300 may be embodied in a separate device or incorporated in one of the group agents. Another configuration of the system could, for example, have the system operator replicated, or distributed, in or across all group agents. In this case, there may be advantages to not relying on a central control using a single system operator and reduction of the need to transmit the Lagrange multiplier. However, more data communication would be necessary. In this regard, each group agent would receive all of the aggregated data (albeit with privacy, as discussed herein) from all of the other group agents.

As shown and described, the example system 200 includes processors and memories. Of course, the processors are configured to execute code, instructions or routines that may be stored on the illustrated memories (or on other appropriate memories) to trigger or cause components of the system (including the processors) to perform or function in suitable manners to implement the presently described embodiments and other objectives.

It will be appreciated by those of skill in the art, upon a reading of the present specification, that the processors and memories may take a variety of forms to implement the presently described embodiments. The processors can be embodied in a variety of hardware forms, such as digital processors, single-core processors, multi-core processors, or coprocessors, or the like. The memories may be any type of tangible non-transitory computer readable medium such as random-access memory (RAM), read only memory (ROM), magnetic disk or tape, optical disk, flash memory, or holographic memory, or the like. In at least one embodiment, the memories may comprise a combination of random-access memory and read only memory portions.

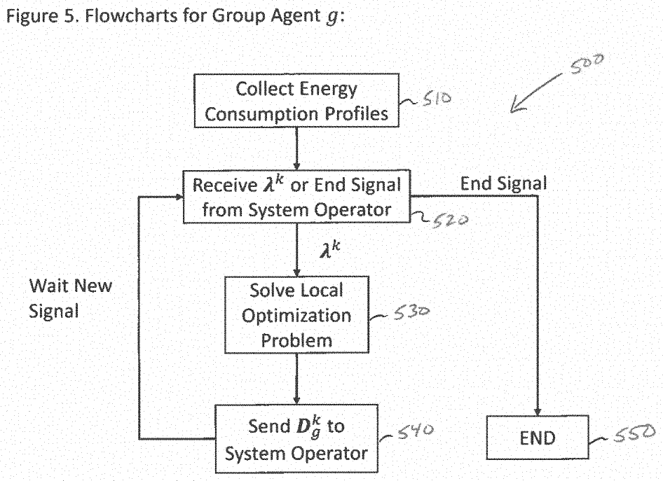

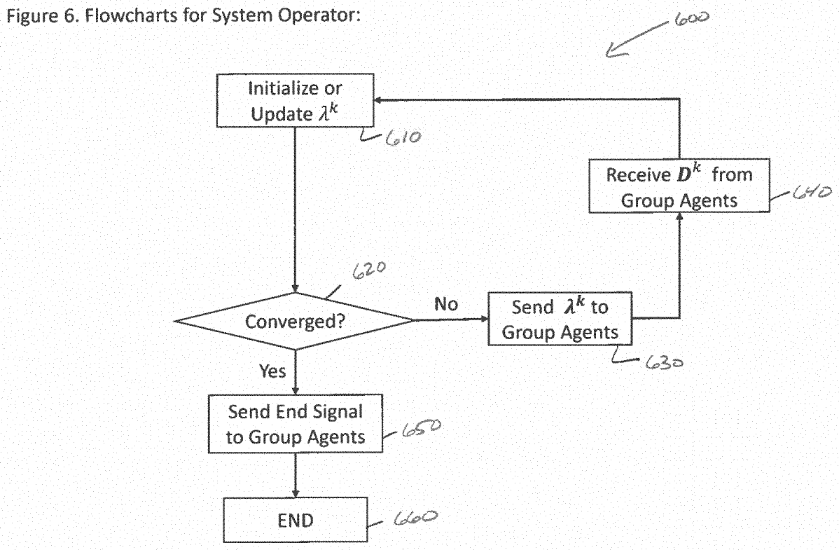

Now with reference to FIGS. 5 and 6, example methods according to the presently described embodiments, are illustrated. It should be appreciated that these methods may be implemented using a system 200 of FIG. 2 or any other suitable system. It should also be recognized that the methods and other methods and techniques according to the presently described embodiments may be implemented using a variety of different configurations of hardware, software code or instructions (e.g., stored on appropriate non-volatile memory devices and executed by suitable processors) and other functional components. For example, various hardware configurations and software routines may be used to trigger or cause the various components of the system to perform necessary functions to achieve the objectives of the presently described embodiments.

Referring now to FIG. 5, an example method 500 relating to operation of each group agent 210 according to the presently described embodiments is illustrated in flowchart form. As shown, the group agents each collect energy consumption profiles (at 510) from users as, for example, described above. The group agent also determines whether the system operator sent λ^{k} or an end signal to the groups agent (at 520). If λ^{k} was sent, then the local optimization problem is solved (at 530) and D_{g}^{k} is sent to the system operator (at 540). The group agent then waits for a new signal to be processed. If, at 520, it is determined that an end signal is received, the process is ended (at 550). It will be understood that when convergence occurs and the process is ended, the group agent then uses the received information, e.g., the Lagrange multiplier, to implement the load management solution provided by the system operator.

With reference now to FIG. 6, an example method 600 relating to operation of the system operator 300 according to the presently described embodiments is illustrated in flowchart form. As shown, the system operator initializes or updates λ^{k} (at 610). The system operator then determines if there is convergence (at 620). If not, λ^{k} is sent back to group agents (at 630). The system operator then receives D_{g}^{k} from group agents (at 640) and performs an update process on λ^{k} (at 610). If, at 620, it is determined that there is convergence, an end signal is sent to the group agents (at 660). It will be understood that when convergence occurs and the process is ended, the group agent then uses the received information, e.g., the Lagrange multiplier, to implement the load management solution provided by the system operator.

As noted, some cases may involve a system operator that is incorporated in one or more group agents. In this regard, the methods of FIGS. 5 and 6 may be implemented and adapted to account for such a change in architecture.

It should be appreciated that the presently described embodiments may be implemented using a variety of configurations. For example, suitable hardware configurations (using, for example, meters, processors, memories, power and/or energy equipment and/or hardware, network architecture, . . . etc.) used with corresponding software routines may be used. In this regard, the execution of the software programs or code stored on memory devices by processors may cause appropriate hardware to act to achieve the objectives of the presently described embodiments. As but one example, a smart meter device may be used in conjunction with a network and suitable processors for an overall system to achieve the desired peak load management.

It should also be understood that, while optimization problems and techniques are described or modeled in connection with the presently described embodiments, other optimization problems and techniques as well as approaches that result in near-optimal or improved solutions could be used in connection with the presently described embodiments.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A privacy preserving method for peak load management of groups in a power and/or energy system, the method comprising:
locally optimizing or improving activities and aggregating load in each group agent;
broadcasting selected aggregated information with or without noise to a system operator or agents for each group; and,
managing a peak load of the system based on at least the selected aggregated information, whereby the managing preserves privacy and attains improved, near-optimal or optimal solutions.

2. The method as set forth in claim 1 wherein a Lagrange multiplier is implemented.

3. A privacy preserving system for peak load management of groups in a power and/or energy system, the system comprising:
a group agent configured to locally optimize or improve activities, aggregate load for a group, and determine selected aggregated information; and,
a system operator configured to selectively manage a peak load of the system based on at least the aggregated information to preserve privacy and attain improved, near-optimal or optimal solutions.

4. The system as set forth in claim 3 wherein a Lagrange multiplier is implemented.

5. A privacy preserving system for peak load management of groups in a power and/or energy system, the system comprising at least one processor and at least one memory having stored thereon code or instructions that, when executed by the processor:
locally optimize or improve activities and aggregate load in each group agent;
broadcast selected aggregated information with or without noise to a system operator or agents for each group; and,
manage a peak load of the system based on at least the selected aggregated information, whereby the managing preserves privacy and attains improved, near-optimal or optimal solutions.

6. The system as set forth in claim 5 wherein a Lagrange multiplier is implemented.

7. A privacy preserving system for peak load management of groups in a power and/or energy system, the system comprising:
a group agent comprising at least one processor and at least one memory having stored thereon code or instructions that, when executed by the processor to locally optimize or improve activities, aggregate load for a group, and transmit selected aggregated information to a system operator configured to selectively manage a peak load of the system based on at least the aggregated information to preserve privacy and attain improved, near-optimal or optimal solutions.

8. The system as set forth in claim 7 wherein a Lagrange multiplier is implemented.

9. A privacy preserving method for peak load management of groups in a power and/or energy system, the method comprising:
a group agent locally optimizing or improving activities;
aggregating load for a group; and,
transmitting to a system operator selected aggregated information, the system operator being configured to selectively manage a peak load of the system based on at least the aggregated information to preserve privacy and attain improved, near-optimal or optimal solutions.

10. The method as set forth in claim 9 wherein a Lagrange multiplier is implemented.

11. A privacy preserving system for peak load management of groups in a power and/or energy system, the system comprising:
a system operator comprising at least one processor and at least one memory having stored thereon code or instructions that, when executed by the processor, receives iteratively selected aggregated information representing aggregate load from at least one group agent, selectively manages a peak load of the system based on at least the aggregated information to preserve privacy and attains improved, near-optimal or optimal solutions.

12. The system as set forth in claim 11 wherein a Lagrange multiplier is implemented.

13. A privacy preserving method for peak load management of groups in a power and/or energy system, the method comprising:
a system operator receiving iteratively selected aggregated information representing aggregate load from at least one group agent; and
selectively managing a peak load of the system based on at least the aggregated information to preserve privacy and attain improved, near-optimal or optimal solutions.

14. The method as set forth in claim 13 wherein a Lagrange multiplier is implemented.
